(19) United States
(12) Patent Application Publication
(10) Pub. No.: US 2025/0014297 A1
(43) Pub. Date: Jan. 9, 2025

(54) SYSTEM AND METHOD FOR ADJUSTING DENTAL MODELS

(71) Applicant: SprintRay, Inc., Los Angeles (CA)

(72) Inventors: Yue Yang, Zhejiang (CN); Jiangtao Ran, Zhejiang (CN); Chuang Chen, Zhejiang (CN)

(21) Appl. No.: 18/764,335

(22) Filed: Jul. 4, 2024

(30) Foreign Application Priority Data
Jul. 5, 2023 (CN) CN202310821948.2

(51) Int. Cl. G06T 19/20

(52) U.S. Cl. CPC G06T 19/20; G06T 2210/41; G06T 2219/2004; G06T 2219/2016

(57) ABSTRACT

The present invention discloses a method, device, storage medium, and medical system for adjusting dental models. Among them, the method includes: obtaining the point cloud data of the dental model in the 3D space; moving the dental model to the preset position in the 3D space based on the point cloud data; and adjusting the dental model at the preset position to the first preset orientation based on the neural network model. The present invention solves the technical problem of low adjustment efficiency of dental models in related technologies.

### CROSS-REFERENCE TO RELATED APPLICATIONS

This application claims priority to CN patent Application No. 2023 1 0821948.2, filed Jul. 5, 2023, the content of which is hereby incorporated by reference in its entirety.

### TECHNICAL FIELD

The present invention generally relates to the field of dental models, including a system and method of adjusting dental models.

### BACKGROUND

At present, during the preprocessing of a dental model, the axial orientation of the dental model is typically adjusted manually in order to improve the quality of the displayed dental model on the user interface, to facilitate recognition of the tooth number in the subsequent automatic recognition of the dental model, and to improve the segmentation result of the dental model. However, during the implementation of the present invention, the inventor found that such a manual adjustment of the dental model requires repeated calibration, resulting in low efficiency of axial adjustment.

Accordingly, there is a need for a system and method for adjusting dental models to address the aforementioned issues.

### SUMMARY

The present invention provides a system and method for adjusting a dental model to improve the adjustment efficiency of dental models in related technologies.

According to one aspect of the present embodiment, a method for adjusting the dental model is provided, including: obtaining the point cloud data of the dental model in the 3D space; moving the dental model to the preset position in the 3D space based on the point cloud data; and adjusting the dental model at the preset position to the first preset orientation based on the neural network model.

Optionally, the first preset orientation is configured to represent at least one of the following: the orientation of the target tooth in the dental model coincides with the orientation of the first axis in the 3D space; the orientation of the occlusal surface of the dental model coincides with the orientation of the second axis in the 3D space; and the orientation of the wide surface of the tooth jaw in the dental model coincides with the orientation of the third axis in the 3D space.

Optionally, adjusting the dental model at the preset position to the first preset orientation based on the neural network model may include: determining feature vectors of the point cloud data; rotating the dental model based on the feature vectors to obtain the rotated dental model; and adjusting the rotated dental model to the first preset orientation based on the neural network model.

Optionally, adjusting the rotated dental model to the first preset orientation based on the neural network model may include: using the DGCNN model to adjust the rotated dental model to the second preset orientation; and using the residual neural network model to adjust the second preset orientation so that adjusting the rotated dental model to the first preset orientation.

Optionally, adjusting the rotated dental model to the second preset orientation by using the DGCNN model may include: using the DGCNN model to determine the first preset direction of the rotated dental model in the 3D space; and adjusting the rotated dental model to the second preset orientation by using the first preset direction.

Optionally, determining the first preset direction of the rotated dental model in the 3D space by using the DGCNN model may include: identifying a first display direction of the rotated dental model in the 3D space by using the DGCNN model; classifying the first display direction to obtain a first category to which the first display direction belongs; and determining the first preset direction corresponding to the first category by using the a preset correspondence, in which the first preset correspondence is configured to represent the correspondence between the first category and the first preset direction.

Optionally, the second preset orientation is configured to represent at least one of the following: the orientation of the target tooth in the rotated dental model coincides with the orientation of the first axis; the orientation of the occlusal surface of the target tooth in the rotated dental model coincides with the target plane; and the target plane is constructed from the first axis and the third axis.

Optionally, adjusting the second preset orientation by using the residual neural network model, so that adjusting the rotated dental model to the first preset orientation may include: determining the second preset direction of the rotated dental model in the 3D space by using the residual neural network model; and adjusting the second preset orientation by using the second preset direction, so that adjusting the rotated dental model to the first preset orientation.

Optionally, determining the second preset direction of the rotated dental model in the 3D space by using the residual neural network model may include: identifying the second display direction of the rotated dental model in the 3D space by using the residual neural network model; classifying the second display direction to obtain the second category to which the second display direction belongs; and determining the second preset direction corresponding to the second category by using the second preset correspondence, in which the second preset correspondence is configured to represent the correspondence between the second category and the second preset direction

Optionally, moving the dental model to the preset position in the 3D space based on the point cloud data may include: determining the middle position of the point cloud data; determining the coordinate origin of the dental model in the 3D space based on the middle position; and moving the dental model to the preset position based on the coordinate origin.

According to one aspect of the present embodiment, a device for adjusting the dental model is provided, including: an acquisition module configured to obtain a point cloud data of a dental model in a 3D space; a moving module configured to move the dental model to a preset position in the 3D space based on the point cloud data; and an adjustment module configured to adjust the dental model at the preset position to a first preset orientation based on a neural network model.

According to one aspect of an embodiment of the present invention, a computer-readable storage medium is provided, including: a stored program which control the processor of the device to execute the method for adjusting the dental model as described herein in any embodiments during the stored program execution.

According to one aspect of an embodiment of the present invention, a medical system is provided, including: one or more processors; and a storage device used to store one or more programs; wherein the one or more programs are executed by the one or more processors, causing the one or more processors to execute the method for adjusting the dental model according to any of the embodiments described herein.

In an embodiment of the present invention, obtaining the point cloud data of the dental model in the 3D space, moving the dental model to the preset position in the 3D space based on the point cloud data, and adjusting the dental model at the preset position to the first preset orientation based on the neural network model achieves the improved adjustment efficiency of the dental model. It is easy to notice that during the adjustment process of the dental model, the point cloud data of the dental model can be combined to move the dental model, which can reduce the manual adjustment process for users. Moreover, the neural network model can be configured to adjust the dental model at the preset position to the first preset orientation, further reducing the adjustment process for users to improve the accuracy of adjustment, and improving the adjustment efficiency of the dental model, thereby solving the technical problem of low adjustment efficiency of the dental model in related technologies.

The above summary contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a flowchart of a method for adjusting a dental model according to some embodiments of the present invention;

FIG. 2 is a schematic diagram of a maxillary model in a dental model according to some embodiments of the present invention;

FIG. 3a is a schematic diagram of a mandibular model in a dental model according to some embodiments of the present invention;

FIG. 3b is a schematic diagram of a mandibular model in a dental model according to some embodiments of the present invention;

FIG. 4 is a schematic diagram of a target tooth in a maxillary model according to some embodiments of the present invention;

FIG. 5 is a schematic diagram of a target tooth in a mandibular model according to some embodiments of the present invention;

FIG. 6 is a schematic diagram of an occlusal surface of a tooth in a maxillary model according to some embodiments of the present invention;

FIG. 7 is a schematic diagram of a wide surface of a tooth jaw in a maxillary model according to some embodiments of the present invention;

FIG. 8 is a rotated mandibular model according to some embodiments of the present invention;

FIG. 9 is a mandibular model in a first preset orientation according to some embodiments of the present invention;

FIG. 10 is a mandibular model in a second preset orientation according to some embodiments of the present invention;

FIG. 11 is a maxillary model in a second preset orientation according to some embodiments of the present invention;

FIG. 12 is a schematic diagram of one category according to some embodiments of the present invention;

FIG. 13 is a schematic diagram of another category according to some embodiments of the present invention; and

FIG. 14 is a schematic diagram of a device for adjusting a dental model according to some embodiments of the present invention.

### DETAILED DESCRIPTION OF EXEMPLARY EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

In order to facilitate a better understanding of the present invention by those skilled in this technical field, the following will provide a clear and complete description of the technical solutions in the embodiments of the present invention, in conjunction with the attached drawings. Obviously, the described embodiments are only a part of the embodiments of the present invention, not all of them. Based on the embodiments in the present invention, all other embodiments obtained by ordinary technicians in this technical field without creative labor shall fall within the scope of protection of the present invention.

It should be noted that the terms “first”, “second”, etc. in the specification and claims of the present invention, as well as the aforementioned figures, are used to distinguish similar objects and do not necessarily need to be used to describe a specific order or sequence. It should be understood that the data used in this way can be interchanged in appropriate cases, so that the embodiments of the present invention described herein can be implemented in order other than those illustrated or described herein. In addition, the terms “including” and “having”, as well as any variations thereof, are intended to cover non-exclusive inclusion, for example, a process, method, system, product, or device that includes a series of steps or units need not be limited to those clearly listed steps or units but may include other steps or units that are not clearly listed or inherent to this process, method, product, or device.

### Embodiment 1

According to some embodiments of the present invention, an embodiment of a method for adjusting the dental model is provided. It should be noted that the steps shown in the flowcharts in the accompanying drawings can be executed in a kind of computer system which can execute a set of computer instructions, and although the logical order is shown in the flowchart, in some cases, the steps shown or described may be executed in a different order than as described herein.

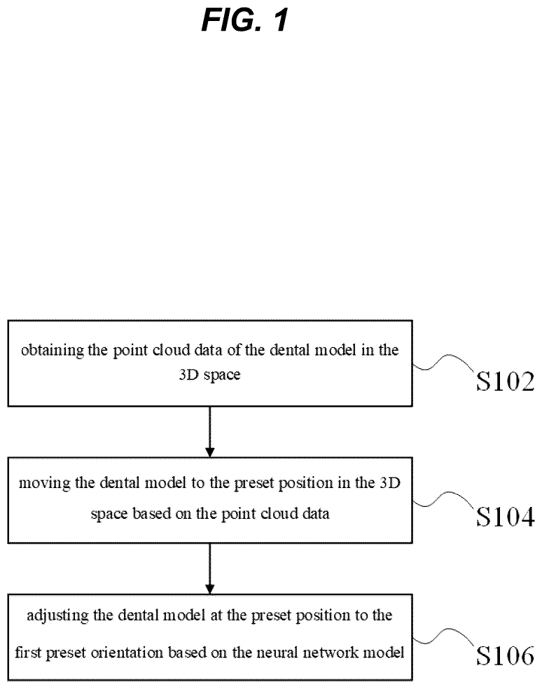

FIG. 1 is a flowchart of a method for adjusting the dental model according to some embodiments of the present invention. As shown in FIG. 1, the method comprises the following steps:

Step S102 includes obtaining the point cloud data of a dental model in the 3D space.

The aforementioned dental model may be a pre-generated dental model based on the patient's teeth information and teeth images, which may include a dental model that has not yet been processed.

The aforementioned dental model may be a 3D model.

The aforementioned point cloud data may be configured to represent the 3D point cloud data of the dental model(s) in the 3D space.

In some optional embodiments, the dental model may be initially moved to an appropriate position by obtaining point cloud data of the dental model in the 3D space.

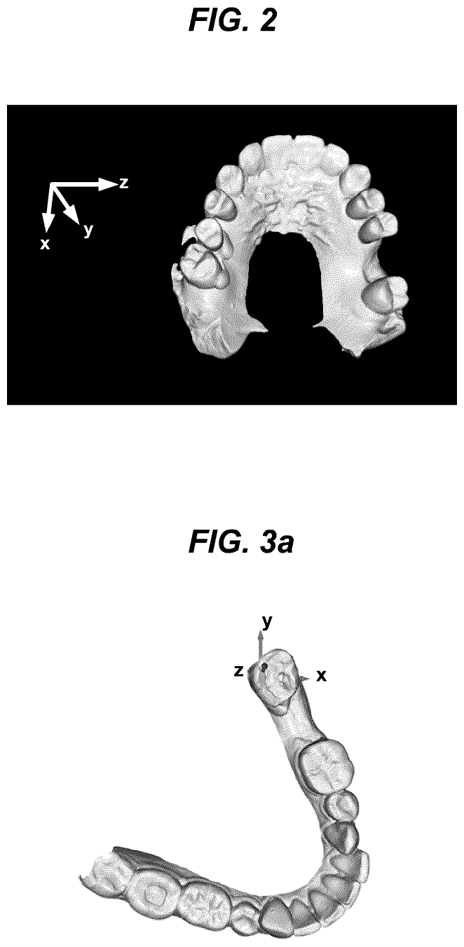

FIG. 2 is a schematic diagram of the maxillary model of an exemplary dental model according to some embodiments of the present invention. The dental model shown in FIG. 2 may be the maxillary model initially displayed in the 3D space, and the left coordinate axis may represent the 3D coordinate system in the 3D space. The 3D coordinate system includes the x-axis, y-axis, and z-axis, and the 3D coordinate system in FIG. 2 may be the world coordinate system.

FIG. 3a is a schematic diagram of the mandibular model of an exemplary dental model according to some embodiments of the present invention. The dental model shown in FIG. 3a may be the mandibular model initially displayed in the 3D space, and the left coordinate axis may represent the 3D coordinate system in the 3D space. The 3D coordinate system includes the x-axis, y-axis, and z-axis, and the 3D coordinate system in FIG. 3a may be the world coordinate system.

Step S104 of FIG. 1 includes moving the dental model to the preset position in the 3D space based on the point cloud data.

The aforementioned preset position may be the central position in the 3D space where the dental model is located and also may be the central position on the display interface. The aforementioned preset position also may be any preset position. This is exemplary only and is not limiting in any way.

The aforementioned preset positions also may be the 3D coordinate origin in the 3D space.

In some optional embodiments, the preset position may be set according to actual needs, so that the dental model may move to a suitable position in the 3D space.

In order to facilitate subsequent tooth detection and segmentation of the dental model, it may be preferable to move the dental model to the central position in the 3D space.

FIG. 3b is a schematic diagram of the mandibular model in an exemplary dental model according to some embodiments of the present invention. The mandibular model shown in FIG. 3b may be the mandibular model at the central position in the 3D space that may be adjusted from the initially displayed mandibular model in the 3D space.

In some optional embodiments, in the actual application of the dental model, in order to facilitate subsequent processing of the dental model, it may be preferable to move the dental model to a preset position in the 3D space when adjusting the axial orientation of the dental model.

Step S106 of FIG. 1 includes adjusting the dental model at the preset position to the first preset orientation based on the neural network model.

The aforementioned neural network model may be a convolutional neural network model but is not limited to this.

The number of aforementioned neural network models may be one or more, and there is no limit on the number of neural network models herein.

The aforementioned first preset orientation may be the orientation of the dental model at the preset position. The first preset orientation may be set according to the actual task scenario. For example, in subsequent processing, the widest surface of the tooth jaw may often be configured as the display surface facing the user, which may be convenient for subsequent tooth segmentation and tooth recognition.

In some optional embodiments, the neural network model may be configured to adjust the dental model at the preset position to the first preset orientation, thereby improving the adjustment efficiency and accuracy of the dental model. Traditional algorithms also may be used to adjust the dental model at the preset position to the first preset orientation.

Through the aforementioned steps, obtaining the point cloud data of the dental model in the 3D space, moving the dental model to the preset position in the 3D space based on the point cloud data, and adjusting the dental model at the preset position to the first preset orientation based on the neural network model, the present invention achieves the technical goal of improving the efficiency of adjusting the dental model. It is easy to notice that during the adjustment process of the dental model, the point cloud data of the dental model may be combined to move the dental model, which may reduce the manual adjustment process for users. The neural network model may be configured to adjust the dental model at the preset position to the first preset orientation, further reducing the adjustment process for users to improve the accuracy of adjustment, and improving the adjustment efficiency of the dental model, thereby solving the technical problem of low adjustment efficiency of the dental model in related technologies.

In the aforementioned embodiments of the present invention, the first preset orientation is configured to represent at least one of the following: the orientation of the target tooth in the dental model coincides with the orientation of the first axis in the 3D space; the orientation of the occlusal surface of the dental model coincides with the orientation of the second axis in the 3D space; and the orientation of the wide surface of the tooth jaw in the dental model coincides with the orientation of the third axis in the 3D space.

The aforementioned first, second, and third axis may be different axes in the 3D coordinate system.

The aforementioned first axis may be the z-axis of the 3D coordinate system in the 3D space, the second axis may be the y-axis of the 3D coordinate system in the 3D space, and the third axis may be the x-axis of the 3D coordinate system in the 3D space. This is exemplary only and is not limiting in any way.

The aforementioned target tooth may be the front tooth in the dental model. In the maxillary model of the dental model, the target tooth may be the upper front tooth, and in the mandibular model of the dental model, the target tooth may be the lower front tooth. The orientation of the target tooth may be determined by the first connecting line obtained from the center point of the dental model to the point between the two front teeth. If the first connecting line is parallel to the first axis, it indicates that the orientation of the target tooth coincides with the orientation of the first axis in the 3D space.

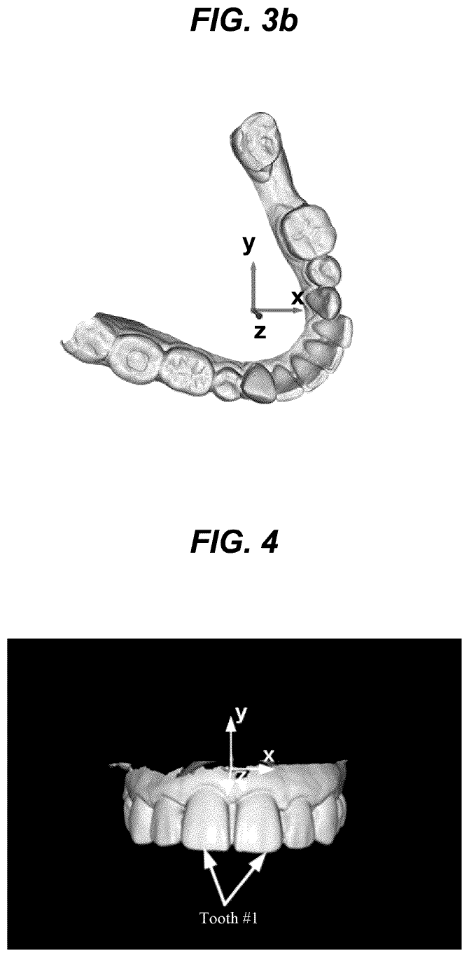

FIG. 4 is a schematic diagram of the target tooth in the maxillary model according to some embodiments of the present invention. As shown in FIG. 4, in the maxillary model, the target tooth may be the tooth #1, that is, the target tooth may be the upper front tooth in the maxillary model.

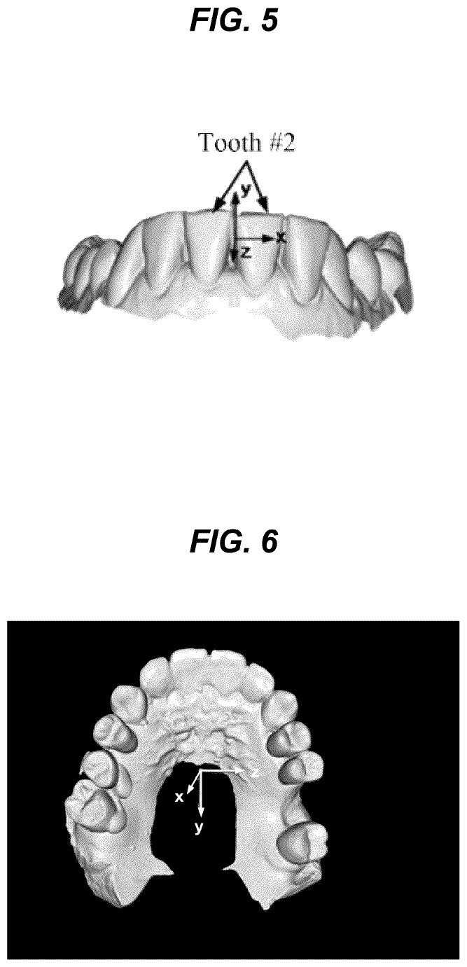

FIG. 5 is a schematic diagram of the target tooth in the mandibular model according to some embodiments of the present invention. As shown in FIG. 5, in the mandibular model, the target tooth may be the tooth #2, that is, the target tooth may be the lower front tooth in the mandibular model.

The aforementioned occlusal surface of the tooth may be the surface where the occlusal site of the tooth is located in the dental model. The orientation of the occlusal surface of the tooth may be determined by the normal of the occlusal surface, which is generally parallel to the second axis, indicating that the orientation of the occlusal surface of tooth coincides with the orientation of the second axis in the 3D space.

FIG. 6 is a schematic diagram of the occlusal surface of a tooth in the maxillary model according to some embodiments of the present invention. As shown in FIG. 6, in the maxillary model, the occlusal surface of the tooth may be the surface where the occlusal site of the tooth is as shown in FIG. 6, that is, the surface composed of the x-axis and y-axis is the occlusal surface of the tooth.

The aforementioned wide surface of the tooth jaw may be the widest surface displayed in the dental model. The wide surface of the tooth jaw may be represented by the connecting lines of the tooth at both ends, which are parallel to the third axis. This indicates that the orientation of the wide surface of the tooth jaw coincides with the orientation of the third axis in the 3D space.

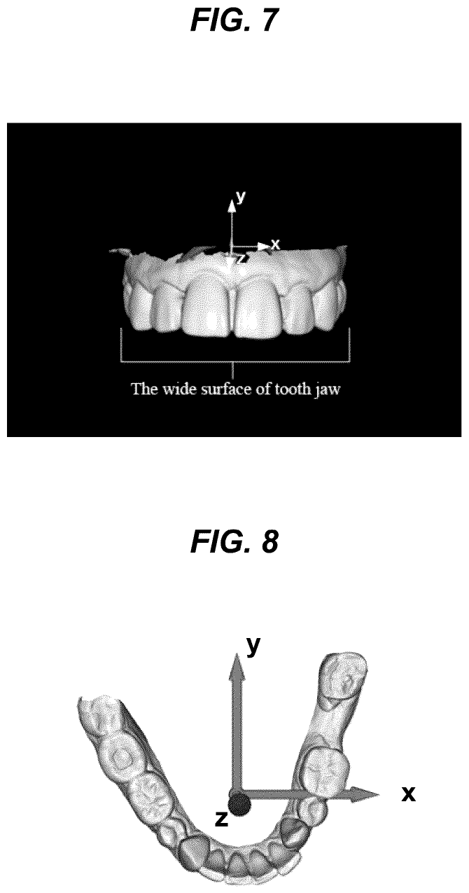

FIG. 7 is a schematic diagram of the wide surface of the tooth jaw in the maxillary model according to some embodiments of the present invention. As shown in FIG. 7, in the maxillary model, the wide surface of the tooth jaw may be determined based on the tooth at both ends of FIG. 7.

By adjusting the dental model to the first preset orientation, users may have a better experience when making the dental model face the users, and it also may be convenient for users to perform subsequent operations on the dental model.

It should be noted that the first preset orientation may be changed according to the user's needs, and the first preset orientation also may be a preset orientation. However, this is not limiting in any way, and this may be set according to actual needs.

In the aforementioned embodiments of the present invention, adjusting the dental model at the preset position to the first preset orientation based on the neural network model may include: determining feature vectors of the point cloud data; rotating the dental model based on the feature vectors to obtain a rotated dental model; and adjusting the rotated dental model to the first preset orientation based on the neural network model.

In some optional embodiments, the spatial placement of the dental model may be normalized by determining the feature vectors of the point cloud data, that is, by rotating the dental model as described above, to obtain the rotated dental model. The neural network may be configured to process the rotated dental model to obtain the rotation angle to which the rotated dental model should be further rotated. The dental model may be adjusted according to the rotation angle, so that the rotated dental model may be adjusted to the first preset orientation.

The feature vectors of point cloud data may be obtained through Principal Component Analysis (PCA) algorithm, where the PCA may be a data dimensionality reduction algorithm. The aforementioned feature vectors may be the feature vectors obtained from the analysis of the point cloud data by using the PCA.

In some optional embodiments, PCA may be configured to analyze point cloud data to obtain feature vectors, where the feature vectors are configured to represent the main orientation of the point cloud data. The feature vectors may be reversely multiplied of the dental model so that the dental model may rotate to the main orientation of the point cloud data, resulting in the rotated dental model. Herein, reverse multiplication may refer to rotating the dental model in reverse order based on the feature vectors of the dental model in the 3D space.

When the dental model is a maxillary model, the feature vectors of the point cloud data corresponding to the maxillary model may be determined, and the maxillary model may be rotated based on the feature vectors to obtain the rotated maxillary model. Optionally, PCA can be used to analyze point cloud data to obtain the feature vectors of the maxillary model. The feature vectors may be multiplied in reverse order with the dental model, so that the maxillary model may rotate to the main orientation of the point cloud data, thereby obtaining the rotated maxillary model.

When the dental model is a mandibular model, the feature vectors of the point cloud data corresponding to the mandibular model may be determined, and the mandibular model may be rotated based on the feature vector to obtain the rotated mandibular model. FIG. 8 shows a rotated mandibular model according to some embodiments of the present invention. As shown in FIG. 8, optionally, PCA may be configured to analyze point cloud data to obtain the feature vectors of the mandibular model. The feature vectors may be multiplied in reverse order with the dental model, so that the mandibular model may rotate to the main orientation of the point cloud data, thereby obtaining the rotated mandibular model.

In some another optional embodiments, the direction of the rotated dental model in the 3D space may be determined based on the neural network model, and the dental model may be adjusted to the first preset orientation based on this direction.

As shown in FIG. 7, the maxillary model may be adjusted to the first preset orientation. The orientation of the target tooth in the maxillary model coincides with the orientation of z-axis in the 3D space. The orientation of the occlusal surface of the tooth in the maxillary model coincides with the orientation of y-axis in the 3D space. The orientation of the wide surface of the tooth jaw in the maxillary model coincides with the orientation of x-axis in the 3D space. The final display effect of the maxillary model is shown in FIG. 7.

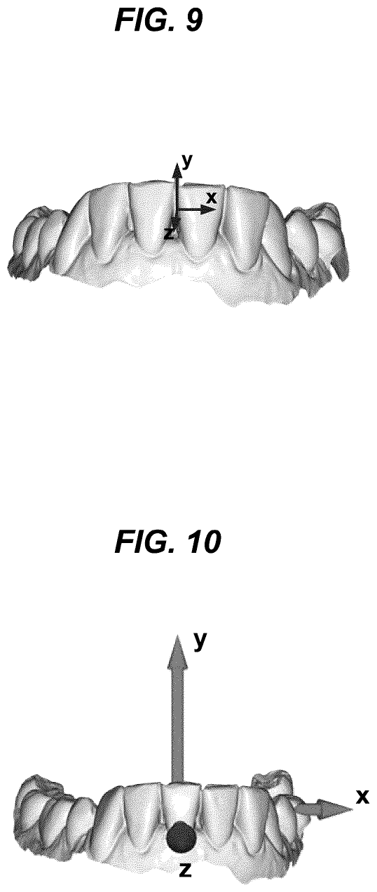

FIG. 9 shows a mandibular model at the first preset orientation according to some embodiments of the present invention. As shown in FIG. 9, the orientation of the target tooth in the mandibular model coincides with the orientation of z-axis in the 3D space, the orientation of the occlusal surface of the tooth in the dental model coincides with the orientation of y-axis in the 3D space, and the orientation of the wide surface of the tooth jaw in the mandibular model coincides with the orientation of x-axis in the 3D space. The final display effect of the mandibular model is shown in FIG. 9.

In the aforementioned embodiments of the present invention, adjusting the rotated dental model to the first preset orientation based on the neural network model may include: using the Dynamic Graph Convolutional Neural Network (DGCNN) model to adjust the rotated dental model to the second preset orientation; and using the residual neural network model to adjust the second preset orientation so that the rotated dental model may be adjusted to the first preset orientation.

In some optional embodiments, due to the high randomness of adjusting the rotated dental model in the 3D space by using the DGCNN model, it may be necessary to add a residual neural network model and then adjust the rotated dental model. The aforementioned second preset orientation may place the dental model on a suitable plane in the 3D space, while the aforementioned first preset orientation may place the dental model in a position directly facing the display.

The aforementioned Dynamic Graph Convolutional Neural Network (DGCNN) for Learning on Point Clouds may be configured for point cloud feature extraction and segmentation.

In some optional embodiments, the DGCNN may be configured to extract the rotated dental model to obtain the point cloud data of the rotated dental model, and to perform point cloud segmentation on the point cloud data to obtain the approximate direction of the rotated dental model in the 3D space, and to rotate the rotated dental model to the second preset orientation for subsequent fine adjustment using residual neural network model to adjust the rotated dental model to the first preset orientation.

The aforementioned residual neural network model is not limiting, for example, it also may include a semi-supervised semantic segmentation network based on deep learning (MinkResUnet), a convolutional neural network for point cloud segmentation, and semantic segmentation (MinkowskiNet).

The aforementioned residual neural network model may be configured for fine adjustment of the second preset orientation, adjusting the rotated dental model to the first preset orientation. By adding a residual neural network model, the accuracy of adjusting the dental model may be improved.

In some optional embodiments, the DGCNN may be configured to roughly adjust the rotated dental model, and then the residual neural network model may be configured to finely adjust the model, so that the dental model may ultimately be accurately adjusted to the first preset orientation.

FIG. 10 shows a mandibular model in the second preset orientation according to some embodiments of the present invention. As shown in FIG. 10, the mandibular model may be adjusted to the second preset orientation, in which the orientation of the target tooth in the rotated dental model coincides with the orientation of z-axis, the occlusal surface of the tooth in the rotated mandibular model coincides with the target plane, and the target plane is constructed from the z-axis and x-axis.

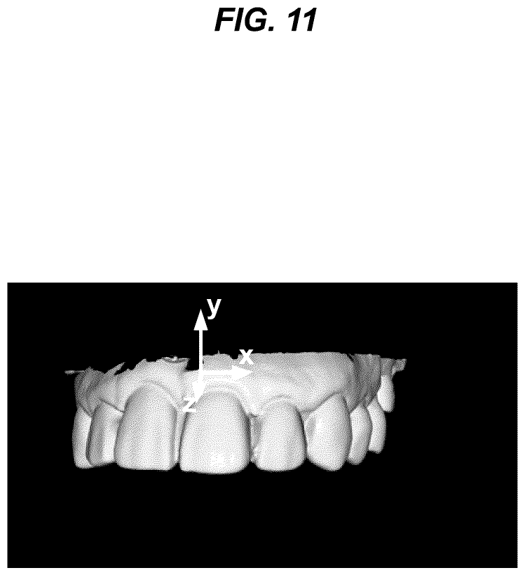

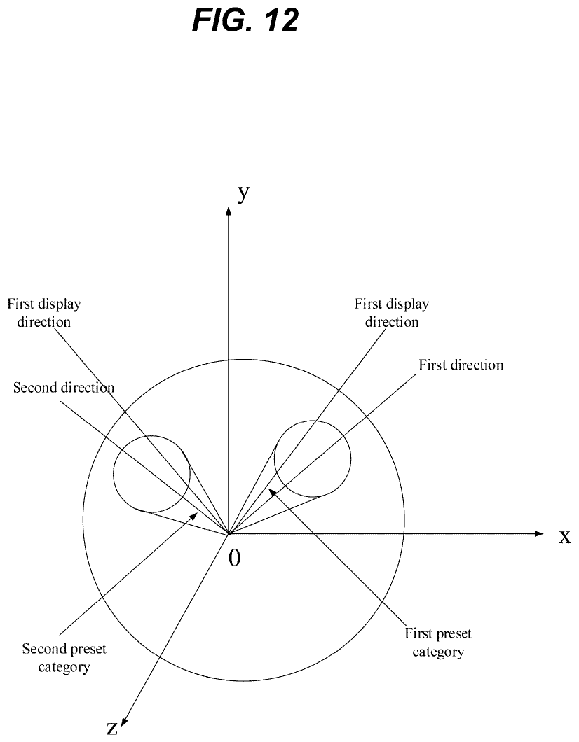

FIG. 11 shows a maxillary model in the second preset orientation according to some embodiments of the present invention. As shown in FIG. 11, the maxillary model may be adjusted to the second preset orientation, in which the orientation of the target tooth in the rotated dental model coincides with the orientation of z-axis, and the occlusal surface of the tooth in the rotated maxillary model coincides with the target plane. The target plane is constructed from the z-axis and x-axis.

In the aforementioned embodiments of the present invention, adjusting the rotated dental model to the second preset orientation by using the DGCNN model may include: using the DGCNN model to determine the first preset direction of the rotated dental model in the 3D space; and adjusting the rotated dental model to the second preset orientation by using the first preset direction.

The aforementioned first preset direction may be the preset direction. By identifying the point cloud data of the rotated dental model, the first preset direction corresponding to the rotated dental model may be obtained.

The DGCNN model may be configured to recognize the rotated dental model, determine the first preset direction of the rotated dental model in the 3D space, and adjust the rotated dental model to the second preset orientation based on the first preset direction of the rotated dental model in the 3D space. Optionally, the rotation relationship between the preset direction and the preset orientation may be preset. After determining the preset direction, the preset direction may be rotated to the preset orientation based on this rotation relationship. For example, if the first preset direction is 20° and the second preset orientation is 40°, and based on the preset rotation relationship, that is, rotating the first preset direction by 20°, the rotated dental model in the first preset direction may be adjusted to the second preset orientation.

In the aforementioned embodiments of the present invention, determining the first preset direction of the rotated dental model in the 3D space by using the DGCNN model may include: identifying the first display direction of the rotated dental model in the 3D space by using the DGCNN model; classifying the first display direction to obtain the first category to which the first display direction belongs; determining the first preset direction corresponding to the first category by using the preset correspondence, in which the first preset correspondence may be configured to represent the correspondence between the first category and the first preset direction.

The aforementioned first display direction may be the actual display orientation of the rotated dental model in the 3D space.

The aforementioned first preset correspondence may be the correspondence between the preset categories and the preset directions. The category may represent the direction of the dental model and may divide the 3D space into 24 categories. These 24 categories may represent equally spaced rotation angles in the 3D space. The number 24 is just an example, and the 3D space may be divided into other numbers of categories, and the degree of the direction between different categories may be the same.

FIG. 12 shows a schematic diagram of one category according to some embodiments of the present invention. As shown in FIG. 12, 24 categories may be described in the 3D space through the display of a sphere. Different categories may be displayed as a cone. It should be noted that the first category includes but is not limited to the first preset category and the second preset category. The first preset direction corresponding to the first preset category may be the first direction (i.e., the direction of the first preset category centerline), the second preset direction corresponding to the second preset category may be the second direction, and the first display direction may be the actual display orientation of the rotated dental model in the 3D space. If the first display direction is displayed in the cone of the first preset category, it may indicate that the first category to which the first display direction belongs is the first preset category. By using the first preset correspondence, it may be determined that the first preset direction corresponding to the first preset category is the first direction. If the first display direction is displayed in the cone of the second preset category, it may indicate that the first category to which the first display direction belongs is the second preset category. By using the first preset correspondence, it may be determined that the second preset direction corresponding to the first preset category is the second direction.

In some optional embodiments, the DGCNN model may be used to recognize the rotated dental model, and to obtain the first display direction of the rotated dental model in the 3D space, that is, the actual display orientation of the rotated dental model in the 3D space. The first display direction may be classified to obtain the first category. Alternatively, the first category corresponding to the first display direction may be determined from multiple preset categories in the 3D space, and the first preset direction referred to by the first category may be determined by retrieving the first preset correspondence relationship.

In the aforementioned embodiments of the present invention, the second preset orientation may be configured to represent at least one of the following: the orientation of the target tooth in the rotated dental model coincides with the orientation of the first axis; the orientation of the occlusal surface of the target tooth in the rotated dental model coincides with the target plane; and the target plane is constructed from the first axis and the third axis.

The aforementioned first axis may be the z-axis of the 3D coordinate system, the second axis may be the y-axis of the 3D coordinate system, and the third axis may be the x-axis of the 3D coordinate system. The target plane may be the plane formed by the x-axis and the z-axis, with the occlusal surface of the tooth coinciding with the target plane.

In the aforementioned embodiments of the present invention, adjusting the second preset orientation by using the residual neural network model, so that adjusting the rotated dental model to the first preset orientation, may include: determining the second preset direction of the rotated dental model in the 3D space by using the residual neural network model; adjusting the second preset orientation by using the second preset direction, so that adjusting the rotated dental model to the first preset orientation.

In some optional embodiments, after adjusting the dental model to the second orientation, the dental model may be further adjusted more finely, so that the dental model may ultimately face the user.

As shown in FIG. 4, the orientation of the target tooth in the rotated dental model coincides with the orientation of the z-axis, the orientation of the occlusal surface of the teeth in the rotated dental model coincides with the orientation of the y-axis, and the orientation of the wide surface of the tooth jaw in the rotated dental model coincides with the x-axis in the 3D space.

The aforementioned second preset direction may be a preset direction. By identifying the point cloud data of the rotated tooth model, the second preset direction corresponding to the rotated tooth model may be obtained.

The residual neural network model may be configured to recognize a rotated dental model and determine the second preset direction of the rotated dental model in the 3D space. The rotated dental model may be adjusted based on the preset rotation relationship between the second preset direction and the first preset orientation, so as to adjust the rotated dental model to the first preset orientation in the 3D space according to the second preset direction of the rotated dental model.

It should be noted that convolutional neural network may be configured to accurately adjust the overall orientation of the dental model, and then residual neural network may be configured to further fine adjust the dental model, thereby improving its adjustment accuracy, and obtaining a better display effect of the dental model.

In the aforementioned embodiments of the present invention, determining the second preset direction of the rotated dental model in the 3D space by using the residual neural network model may include: identifying the second display direction of the rotated dental model in the 3D space by using the residual neural network model; classifying the second display direction to obtain the second category to which the second display direction belongs; determining the second preset direction corresponding to the second category by using the second preset correspondence, in which the second preset correspondence may be configured to represent the correspondence between the second category and the second preset direction.

The aforementioned second display direction may be the actual display orientation of the rotated dental model in the 3D space.

The number of the categories of the second preset correspondence may be greater than the number of categories in the first preset correspondence.

The second preset correspondence may be configured for more precise category classification.

The aforementioned second preset correspondence may be the correspondence between preset category and preset direction, where category is configured to represent the direction of the dental model. The 3D space may be divided into 37 categories, which may represent equally spaced rotation angles in the 3D space. Among the 37 categories, the degree difference between the preset directions corresponding to each category may be 5°. The 37 categories and the 5° difference are shown for example only and are not limiting. The 3D space also may be divided into other numbers of categories, and the degree of the direction between different categories may be the same.

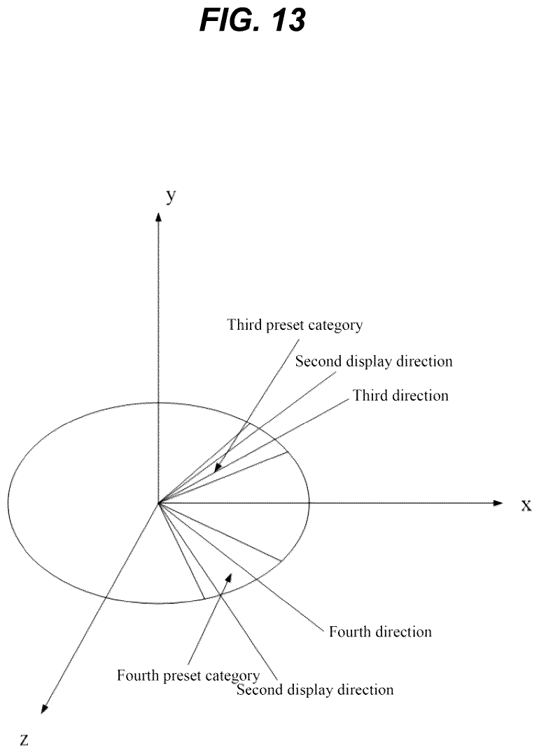

FIG. 13 is a schematic diagram of another category according to some embodiments of the present invention. As shown in FIG. 13, the schematic may abstractly describe the second display direction of the rotated dental model in the 3D space. It should be noted that the second category includes but is not limited to the third preset category, and the fourth preset category. The second preset direction corresponding to the third preset category may be the third direction, the second preset direction corresponding to the fourth preset category may be the fourth direction, and the second display direction may be the actual display orientation of the rotated dental model in the 3D space. The second display direction may be projected onto the plane constructed by the x-axis and z-axis. If the projection direction of the second display direction is displayed in the third preset category, it may indicate that the second category to which the second display direction belongs is the third preset category. By using the second preset correspondence, it can be determined that the second preset direction corresponding to the third preset category may be the third direction, if the second category to which the second display direction belongs is the fourth preset category. By using the second preset correspondence, it can be determined that the second preset direction corresponding to the fourth preset category may be the fourth direction.

In some optional embodiments, the residual neural network model may be configured to recognize the rotated dental model, obtaining the second display direction of the rotated dental model in the 3D space, that is, the actual display orientation of the rotated dental model in the 3D space. The second display direction may be classified to obtain the second category. Alternatively, the second category corresponding to the second display direction may be determined from the preset category in the 3D space, and the second preset direction corresponding to the second category may be determined by calling the second preset correspondence.

In the aforementioned embodiments of the present invention, moving the dental model to the preset position in the 3D space based on the point cloud data may include: determining a middle position of the point cloud data; determining the coordinate origin of the dental model in the 3D space based on the middle position; and moving the dental model to the preset position based on the coordinate origin.

In some optional embodiments, the middle position of the point cloud data may be calculated using relevant calculation methods, and based on this middle position, reverse movement may be performed to obtain the 3D coordinate origin of the dental model in the 3D space. The dental model may be moved to the preset position based on the 3D coordinate origin. Alternatively, the preset position may be the 3D coordinate origin, and the dental model may be moved to the 3D coordinate origin.

### Embodiment 2

In another aspect of the embodiments of the present invention, a schematic diagram of an adjustment device for a dental model is provided. This device may perform the adjustment method of the dental model described in Embodiment 1. The specific implementation and application scenarios in this embodiment may be the same as those in Embodiment 1, and are therefore not repeated here.

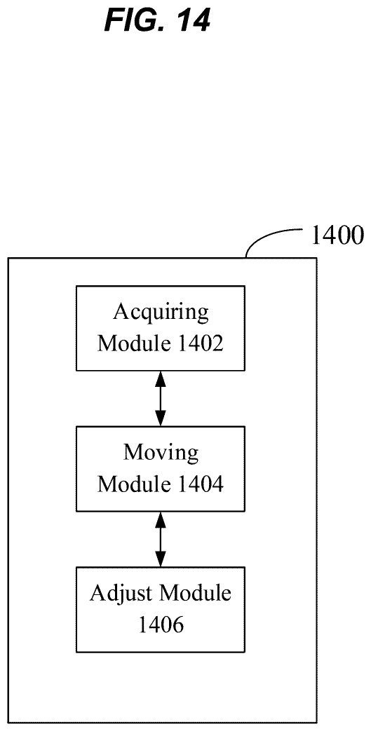

FIG. 14 shows a schematic diagram of a device for adjusting the dental model according to some embodiments of the present invention. As shown in FIG. 14, the device 1400 may comprise an acquisition module 1402, a movement module 1404, and an adjustment module 1406.

The acquisition module may be configured to obtain the point cloud data of the dental model in the 3D space. The movement module may be configured to move the dental model to the preset position in the 3D space based on the point cloud data. The adjustment module may be configured to adjust the dental model at the preset position to the first preset orientation based on the neural network model.

In the aforementioned embodiments of the present invention, the first preset orientation may be configured to represent at least one of the following: the orientation of the target tooth in the dental model coincides with the orientation of the first axis in the 3D space; the orientation of the occlusal surface of the dental model coincides with the orientation of the second axis in the 3D space; and the orientation of the wide surface of the tooth jaw in the dental model coincides with the orientation of the third axis in the 3D space.

In the aforementioned embodiments of the present invention, the adjustment module may be configured to determine feature vectors of the point cloud data, may rotate the dental model based on the feature vectors to obtain a rotated dental model, and may adjust the rotated dental model to the first preset orientation based on the neural network model.

In the aforementioned embodiments of the present invention, the adjustment module may be configured to adjust the rotated dental model by using the point cloud DGCNN model, so that the rotated dental model may be adjusted to the second preset orientation, and to adjust the rotated dental model by using the residual neural network model, so that the rotated dental model may be adjusted to the first preset orientation.

In the aforementioned embodiments of the present invention, the adjustment module may be configured to determine the first preset direction of the rotated dental model in the 3D space by using the point cloud DGCNN model. The rotated dental model may then be adjusted based on the first preset direction, so that the rotated dental model may be adjusted to the second preset orientation.

In the aforementioned embodiments of the present invention, the adjustment module may be configured to identify the first display direction of the rotated dental model in the 3D space using the point cloud DGCNN model. The first display direction may be classified to obtain the first category to which the first display direction belongs. The first preset direction corresponding to the first category may then be determined by using the first preset correspondence, where the first preset correspondence represents the relationship between the category and the first preset direction.

In the aforementioned embodiments of the present invention, the adjustment module is configured to represent at least one of the followings: the orientation of the target tooth in the rotated dental model coincides with the orientation of the first axis, and the occlusal surface of the rotated dental model coincides with the target plane, where the target plane is constructed from the first axis (e.g., the z-axis) and the third axis (e.g., the x-axis).

In the aforementioned embodiments of the present invention, the adjustment module may be configured to determine the second preset direction of the rotated dental model in the 3D space by using the residual neural network model and adjust the rotated dental model to the second preset orientation by using the second preset direction.

In the aforementioned embodiments of the present invention, the adjustment module may be configured to identify the second display direction of the rotated dental model in the 3D space by using the residual neural network model. The second display direction may be classified to obtain the second category to which the second display direction belongs. The second preset direction corresponding to the second category may then be determined by using the second preset correspondence, where the second preset correspondence represents the relationship between the category and the second preset direction.

In the aforementioned embodiments of the present invention, the adjustment module may be further configured to determine the middle position of the point cloud data, determine the coordinate origin of the dental model in the 3D space based on the middle position, and move the dental model to the preset position based on the coordinate origin.

### Embodiment 3

According to one aspect of the embodiments of the present invention, a computer-readable storage medium is provided. The computer-readable storage medium includes a stored program, which controls the processor of the device to execute the method for adjusting the dental model according to any one of the aforementioned embodiments during the stored program execution.

### Embodiment 4

According to one aspect of the embodiments of the present invention, a medical system is provided, comprising: one or more processors; a storage device for storing one or more programs. When one or more programs are executed by the one or more processors, the one or more processors perform the method for adjusting the dental model according to any one of the embodiments described herein.

The sequence numbers of the embodiments of the present invention mentioned above are merely for illustrative purposes and do not necessarily indicate the quality of the embodiments.

In the above embodiments of the present invention, the descriptions of various embodiments each have their own focus. Parts that are not detailed in a particular embodiment can refer to the relevant descriptions in other embodiments.

In the several embodiments provided by this application, it should be understood that the disclosed technical content can be implemented in other ways. The device embodiments described above are merely illustrative. For example, the division of units may be a logical functional division, and other division methods may be adopted in actual implementation. For instance, multiple units or components may be combined or integrated into another system, some features may be omitted, or may not be executed. Additionally, the coupling or direct coupling or communication connection shown or discussed between each other can be an indirect coupling or communication connection through some interfaces, units, or modules, and can be electrical or other forms.

The described units as separate components can be physically separate or not. The components shown as units can be physical units or not, meaning they can be located in one place or distributed across multiple units. Portions or all of the units may be selected as needed to achieve the purposes of the embodiment.

Furthermore, in each embodiment of the present invention, various functional units can be integrated into one processing unit, or each unit can exist independently physically, or two or more units can be integrated into one unit. The integrated units can be realized in the form of hardware or as software functional units.

If the integrated unit is implemented in the form of a software functional unit and sold or used as an independent product, it can be stored in a computer-readable storage medium. Based on this understanding, the technical solution of the present invention, in essence, or the part contributing to the prior art, or all or part of the technical solution, can be embodied in the form of a software product. This computer software product may be stored in a storage medium, including several instructions to enable a computer device (which can be a personal computer, server, or network device, etc.) to execute all or part of the steps described in each embodiment of the present invention. The aforementioned storage medium may include USB drives, read-only memory (ROM), random access memory (RAM), mobile hard drives, magnetic disks, optical disks, and various other media that can store program codes.

The above descriptions are merely the preferred embodiments of the present invention. It should be noted that for those skilled in the art, several improvements and modifications can be made without departing from the principles of the present invention. These improvements and modifications should also be regarded as within the protection scope of the present invention.

It is understood that any aspect or element of any embodiment of the system or method described herein may be combined with any other aspect or element of any other embodiment of the system or method to form additional embodiments of the system or method, all of which are within the scope of the present invention.

While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method for adjusting a dental model, comprising:
obtaining a point cloud data of a dental model in a 3D space;
moving the dental model to a preset position in the 3D space based on the point cloud data;
adjusting the dental model at the preset position to a first preset orientation based on a neural network model.

2. The method of claim 1, wherein the first preset orientation is configured to represent at least one of the following:
an orientation of a target tooth in the dental model coincides with an orientation of a first axis in the 3D space,
an orientation of an occlusal surface of the dental model coincides with the orientation of a second axis in the 3D space, and
an orientation of a wide surface of the tooth jaw in the dental model coincides with the orientation of a third axis in the 3D space.

3. The method of claim 2, further comprising:
adjusting the dental model at the preset position to the first preset orientation based on the neural network model, including:
determining feature vectors of the point cloud data;
rotating the dental model based on the feature vectors to obtain a rotated dental model; and
adjusting the rotated dental model to the first preset orientation based on the neural network model.

4. The method of claim 3, further comprising:
adjusting the rotated dental model to the first preset orientation based on the neural network model, including:
using a Dynamic Graph Convolutional Neural Network (DGCNN) model to adjust the rotated dental model to a second preset orientation; and
using a residual neural network model to adjust the second preset orientation to adjust the rotated dental model to the first preset orientation.

5. The method of claim 4, further comprising:
adjusting the rotated dental model to the second preset orientation by using the DGCNN model, including:
using the DGCNN model to determine the first preset direction of the rotated dental model in the 3D space; and
adjusting the rotated dental model to the second preset orientation by using the first preset direction.

6. The method of claim 5, further comprising:
determining the first preset direction of the rotated dental model in the 3D space by using the DGCNN model, including:
identifying a first display direction of the rotated dental model in the 3D space by using the DGCNN model;
classifying the first display direction to obtain a first category to which the first display direction belongs; and
determining the first preset direction corresponding to the first category by using a first preset correspondence,
wherein the first preset correspondence is configured to represent the correspondence between the first category and the first preset direction.

7. The method of claim 4, further comprising:
configuring the second preset orientation to represent at least one of the following:
the orientation of the target tooth in the rotated dental model coincides with the orientation of the first axis,
the orientation of the occlusal surface of the target tooth in the rotated dental model coincides with a target plane, and
the target plane is constructed from the first axis and the third axis.

8. The method of claim 4, further comprising:
adjusting the second preset orientation by using the residual neural network model to adjust the rotated dental model to the first preset orientation, including:
determining the second preset direction of the rotated dental model in the 3D space by using the residual neural network model; and
adjusting the second preset orientation by using the second preset direction to adjust the rotated dental model to the first preset orientation.

9. The method of claim 8, further comprising:
determining the second preset direction of the rotated dental model in the 3D space by using the residual neural network model, including:
identifying a second display direction of the rotated dental model in the 3D space by using the residual neural network model;
classifying the second display direction to obtain a second category to which the second display direction belongs; and
determining the second preset direction corresponding to the second category by using a second preset correspondence,
wherein the second preset correspondence is configured to represent the correspondence between the second category and the second preset direction.

10. The method of claim 1, further comprising:
moving the dental model to the preset position in the 3D space based on the point cloud data, including:
determining a middle position of the point cloud data;
determining a coordinate origin of the dental model in the 3D space based on the middle position; and
moving the dental model to the preset position based on the coordinate origin.

11. A device for adjusting a dental model, comprising:
an acquisition module configured to obtain a point cloud data of a dental model in a 3D space;
a moving module configured to move the dental model to a preset position in the 3D space based on the point cloud data; and
an adjustment module configured to adjust the dental model at the preset position to a first preset orientation based on a neural network model.

12. A non-transitory computer readable medium, having stored thereon, instructions that when executed by a computing device, cause the computing device to perform operations for adjusting a dental model, the operations comprising:
obtaining a point cloud data of a dental model in a 3D space;
moving the dental model to a preset position in the 3D space based on the point cloud data;
adjusting the dental model at the preset position to a first preset orientation based on a neural network model.

13. The non-transitory computer-readable medium of claim 12, wherein the first preset orientation is configured to represent at least one of the following:
an orientation of a target tooth in the dental model coincides with an orientation of a first axis in the 3D space,
an orientation of an occlusal surface of the dental model coincides with the orientation of a second axis in the 3D space, and
an orientation of a wide surface of the tooth jaw in the dental model coincides with the orientation of a third axis in the 3D space.

14. The non-transitory computer-readable medium of claim 13, the operations further comprising:
adjusting the dental model at the preset position to the first preset orientation based on the neural network model, including:
determining feature vectors of the point cloud data;
rotating the dental model based on the feature vectors to obtain a rotated dental model; and
adjusting the rotated dental model to the first preset orientation based on the neural network model.

15. The non-transitory computer-readable medium of claim 14, the operations further comprising:
adjusting the rotated dental model to the first preset orientation based on the neural network model, including:
using a Dynamic Graph Convolutional Neural Network (DGCNN) model to adjust the rotated dental model to a second preset orientation; and
using a residual neural network model to adjust the second preset orientation to adjust the rotated dental model to the first preset orientation.

16. The non-transitory computer-readable medium of claim 15, the operations further comprising:
adjusting the rotated dental model to the second preset orientation by using the DGCNN model, including:
using the DGCNN model to determine the first preset direction of the rotated dental model in the 3D space; and
adjusting the rotated dental model to the second preset orientation by using the first preset direction.

17. The non-transitory computer-readable medium of claim 16, the operations further comprising:
determining the first preset direction of the rotated dental model in the 3D space by using the DGCNN model, including:
identifying a first display direction of the rotated dental model in the 3D space by using the DGCNN model;
classifying the first display direction to obtain a first category to which the first display direction belongs; and
determining the first preset direction corresponding to the first category by using a first preset correspondence,
wherein the first preset correspondence is configured to represent the correspondence between the first category and the first preset direction.

18. The non-transitory computer-readable medium of claim 15, the operations further comprising:
configuring the second preset orientation to represent at least one of the following:
the orientation of the target tooth in the rotated dental model coincides with the orientation of the first axis,
the orientation of the occlusal surface of the target tooth in the rotated dental model coincides with a target plane, and
the target plane is constructed from the first axis and the third axis.

19. The non-transitory computer-readable medium of claim 15, the operations further comprising:
adjusting the second preset orientation by using the residual neural network model to adjust the rotated dental model to the first preset orientation, including:
determining the second preset direction of the rotated dental model in the 3D space by using the residual neural network model; and
adjusting the second preset orientation by using the second preset direction to adjust the rotated dental model to the first preset orientation.

20. The non-transitory computer-readable medium of claim 19, the operations further comprising:
determining the second preset direction of the rotated dental model in the 3D space by using the residual neural network model, including:
identifying a second display direction of the rotated dental model in the 3D space by using the residual neural network model;
classifying the second display direction to obtain a second category to which the second display direction belongs; and
determining the second preset direction corresponding to the second category by using a second preset correspondence,
wherein the second preset correspondence is configured to represent the correspondence between the second category and the second preset direction.
